(19) United States
(12) Patent Application Publication
(10) Pub. No.: US 2010/0294910 A1
(43) Pub. Date: Nov. 25, 2010

(54) Elastomeric coated frame hanger

(76) Inventors: Jackie Grant Orsini, Huntersville, NC (US); Hallie Sheppard, Baltimore, NC (US); Natalia Johnson, Statesville, NC (US); Christopher John Parke, Cornelius, NC (US)

Correspondence Address: TAFT, STETTINIUS & HOLLISTER LLP, SUITE 1800, 425 WALNUT STREET, CINCINNATI, OH, 45202-3957, US

(21) Appl. No.: 12/798,916

(22) Filed: Apr. 13, 2010

Related U.S. Application Data
(60) Provisional application No. 61/212,643, filed on Apr. 14, 2009.

(51) Int. Cl. A47G 1/20; F16B 45/00

(52) U.S. Cl. 248/475.1

(57) ABSTRACT

Devices, apparatuses, systems and/or methods related to hanging articles (such as picture frames, framed mirrors and other articles) on a surface (such as a wall). Specifically, the disclosed devices, apparatuses, systems and/or methods relate to hangers having an elastomeric coating thereon to protect the surface on which the frame (or other article) is to be hung, as well as to prevent the frame fastener from sliding in the hanger.

### CROSS-REFERENCE TO RELATED APPLICATIONS

This application claims the benefit of U.S. Provisional Application Ser. No. 61/212,643, entitled “ELASTOMERIC COATED PICTURE HANGER,” filed on Apr. 14, 2009, the disclosure of which is incorporated herein by reference.

### BACKGROUND

In the field of frame hangers, it has been found that most hanging article hangers fail to provide protection for walls and tend to scuff and/or scrape walls over time. Further, frames being supported by the same tend to lean or become crooked over time. This problem has been addressed, jr.) part, by some patents including, but not limited to, U.S. Pat. Nos. 6,095,465 and 6,206,334 by utilizing adhesive-backed foam. However, such a solution, while protecting the walls may be useful, does not protect the walls from portions of the hanger that are not covered by the adhesive backed foam (such as the hook) during installation of the hook. Further, the adhesive is only generally effective for a one time application and may pull off paint when removed from the wall. Finally, the adhesive-backed foam does nothing to help retain the frame wires in a single position in the hanger.

Therefore, it would be desirable to have a frame hanger that is relatively simple and easy to use, that may be useable multiple times, that may be cheaply and easily manufactured, that protects substrates (such as walls) to which it is attached, and that helps retain the frame wire without letting it slide out of place.

### SUMMARY OF THE DISCLOSURE

This disclosure is drawn to devices, apparatuses, systems and/or methods related to hanging articles (such as picture frames, framed mirrors and other articles) on a surface (such as a wall). Specifically, the disclosed devices, apparatuses, systems and/or methods relate to hangers having an elastomeric coating thereon to protect the surface on which the frame (or other article) is to be hung, as well as to prevent the frame fastener from sliding in the hanger. While the present disclosure describes frame hangers as example embodiments, any hanging article may be hung by the disclosed hangers.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

In the drawings:

FIG. 1 is a diagram depicting an example embodiment of the present invention.

FIG. 2 is a diagram depicting another example embodiment of the present invention.

FIG. 3 is a diagram depicting yet another example embodiment of the present invention.

FIG. 4 is a diagram depicting a further example embodiment of the present invention.

FIG. 5 is a diagram depicting even yet another example embodiment of the present invention.

FIG. 6 is a diagram depicting another example embodiment of the present invention.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and make part of this disclosure.

In some embodiments, a frame hanger for hanging framed pictures, mirrors, and the like on walls or similar surfaces is provided. An exemplary frame hanger may be manufactured cheaply and may be reused multiple times. An exemplary frame hanger may protect walls from being damaged from indentations, scratches and the like. Further, an exemplary frame hanger may substantially maintain a frame fastener (such as frame wire) in a single position by utilizing friction between the frame hanger and the frame fastener.

In an exemplary embodiment, a frame hanger may be dipped and/or coated in an elastomeric material. Elastomeric materials may include rubbers, plastics and/or polymers (e.g., polyvinyl chloride, NEO-T, any type of vinyl), among others. In some embodiments, a frame hanger may be a metal (e.g., carbon or stainless steel, aluminum, brass) frame hanger that has been dipped and/or coated in a rubber and/or rubber-like material. Some frame hangers may include a hole or opening for receiving a screw, nail or other fastener so that the frame hanger may be fixed to the wall. Some embodiments may include multiple holes for fixing the frame hanger to a wall using fasteners.

The elastomeric coating may be applied by dipping and/or coating at least a portion, if not the entire, hanger. In some examples, the hanger may be twice dipped into a bath of desired elastomeric coating in 2 directions. Some embodiments may leave an area for nails or other fasteners open and not coated.

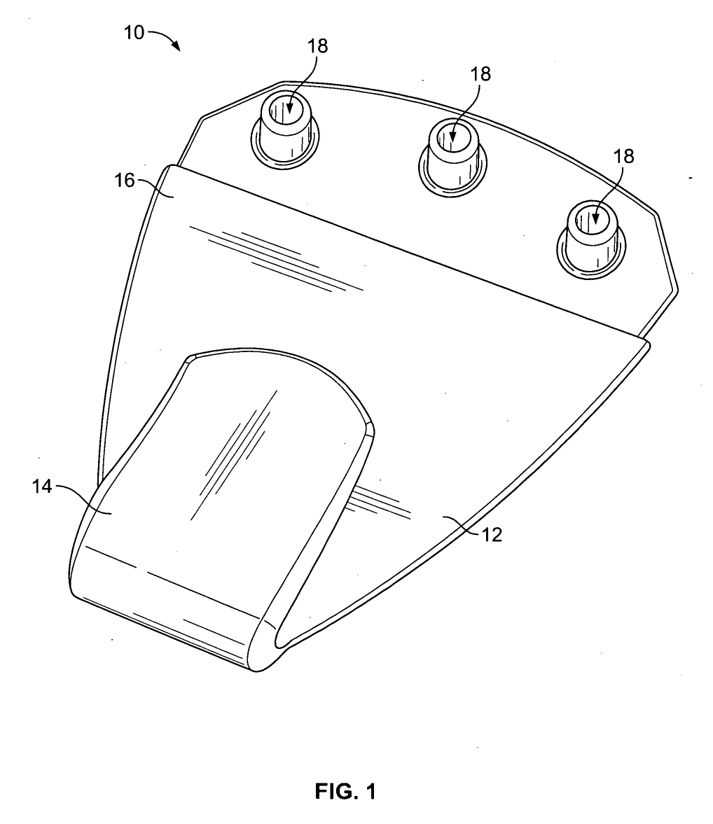

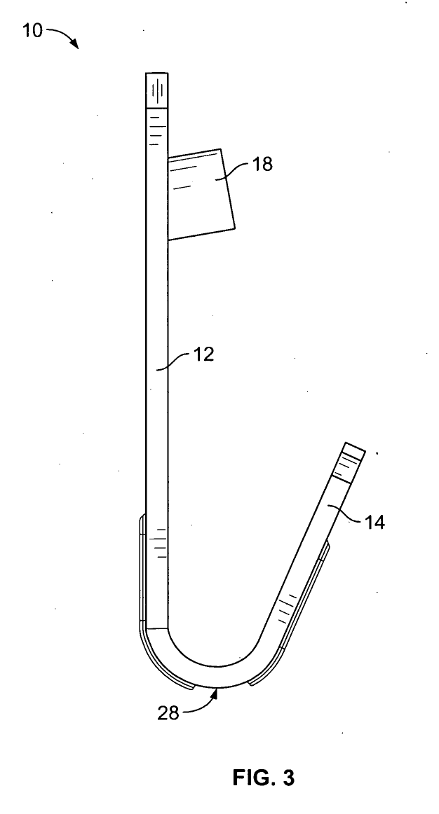

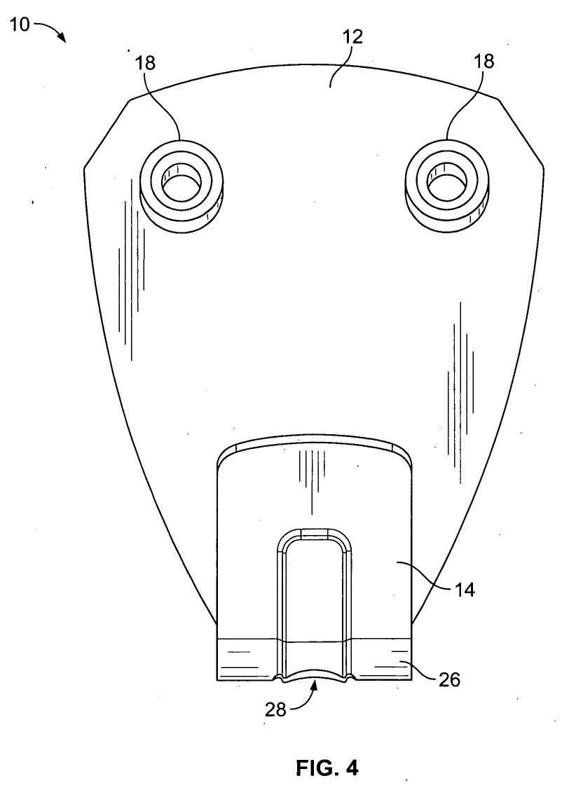

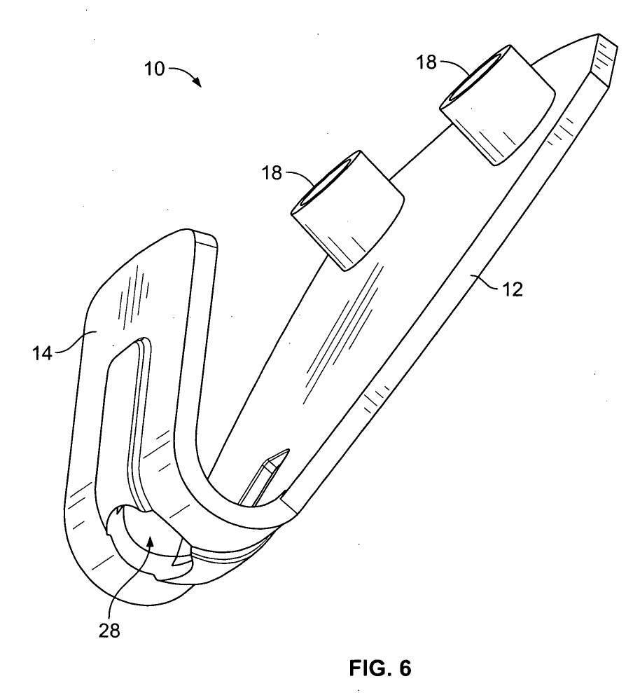

An exemplary embodiment, as depicted in FIG. 1, may include a hanging member 10 having a bracing segment 12 and a hook segment 14. The bracing segment 12 may engage a substrate (e.g., a wall made of wood, plastic, plaster, drywall, concrete and/or brick) and/or brace the hanging member 10 against the substrate. The hook segment 14 may receive a frame fastener (e.g., a frame wire) and/or support the frame fastener. The hanging member 10 (or at least a portion thereof) may be covered by an elastomeric coating 16. FIGS. 3-6 depict additional views of some embodiments.

Some embodiments may further include a substrate fastener 20 (e.g., nail, screw, pin) for attaching, permanently or temporarily, the hanging member to the substrate. In some embodiments, the hanging member may include one or more holes 18 therethrough to receive a substrate fastener 20. For example, the hanging member 10 may have two holes 18 for attaching the hanging member 10 to a wall. Each of the two holes 18 may receive a nail 20 for attaching the hanging member to the wall.

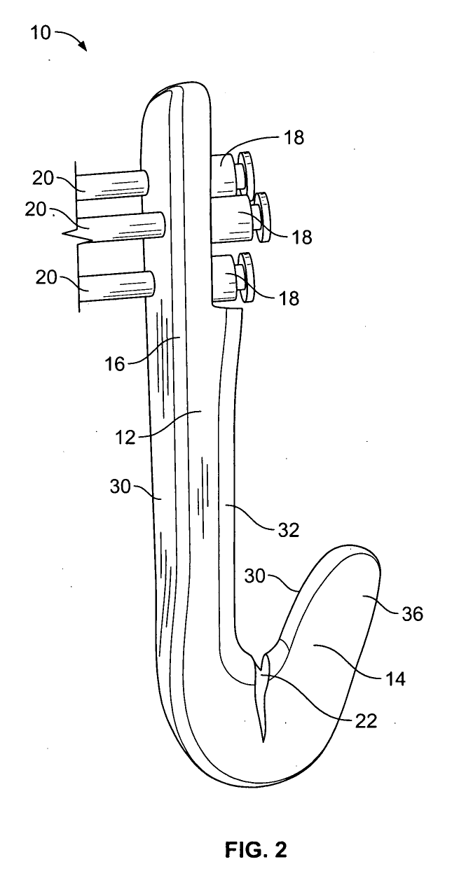

In some embodiments, the entire hanger may be covered and/or coated by the elastomeric coating 16 (see FIG. 2, for example). Other embodiments may provide that less than the entire hanger (i.e., only a portion) of the hanger is covered by the elastomeric coating 16 (see FIG. 1, for example). Some embodiments may include an elastomeric coating 16 covering at least a portion of the bracing segment 12. Some embodiments may include an elastomeric coating 16 covering at least a portion of the hook segment 14. The thickness of the elastomeric coating 16 may vary depending on application, hanging member 10 size, bracing segment 12 size, hook segment 14 size, bend of the hanging member 10 and/or other variables.

The hanging member 10 may include several faces (or surfaces). In some examples, the bracing segment 12 may include two faces, a substrate-engaging surface 30 and bracing segment frame-facing surface 32. The elastomeric coating 16 may cover a portion of the substrate-engaging surface 30 and/or bracing segment frame-facing surface 32. In some examples, the hook segment 14 may include two faces, a frame fastener-receiving surface 34 and hook segment frame-facing surface 36. The elastomeric coating 16 may cover a portion of the frame fastener-receiving surface 34 and hook segment frame-facing surface 36.

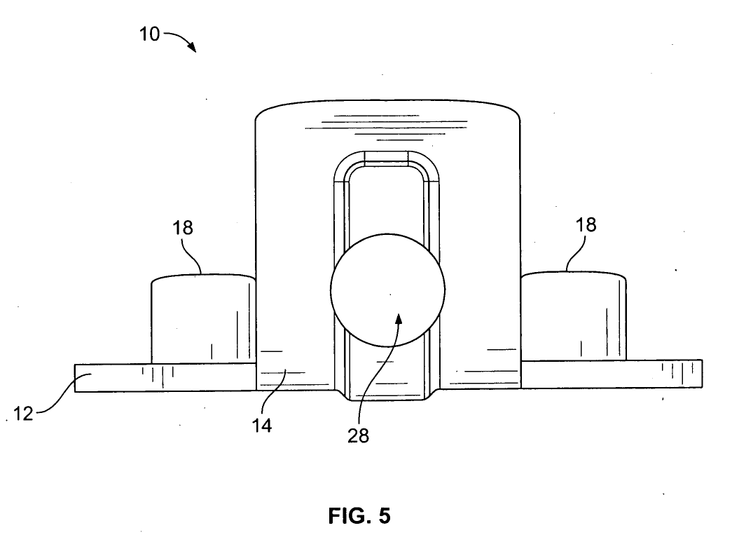

The hanger may be stamped and/or bent into the desired shape, as is known in the art. However, other manufacturing methods may be implemented. In an exemplary embodiment, the hanging member 10 includes a metal member, as depicted in FIG. 5, for example, bent and/or stamped to distinguish the bracing segment 12 from the hook segment 14. Some examples may include a first metal member (bracing segment) 12 and a second metal member (hook segment) 14 coupled together to form the hanger. In some examples, the hanger may be comprised of metals, plastics, rubbers and/or polymers.

In an exemplary embodiment, the elastomeric coating 16 may be notched, grooved, cut or otherwise removed to reduce lateral movement of the frame fastener within the hanger. By restricting and/or reducing lateral movement, the frame hanger may keep the frame “level” to an observer. This may occur due to friction between the frame fastener and the elastomeric coating 16. In some examples, testing has shown that a 30% greater force may be required to laterally slide picture frame wires hung using elastomeric coated hangers in accordance with exemplary embodiments described herein. For example, a “V-shaped” cut 22 near the junction of the bracing segment 12 and the hook segment 14 may increase friction between the frame fastener and the elastomeric coating 16 at the cut point 22. Such a notch 22 may also substantially restrict and/or prevent the frame fastener from damaging the elastomeric coating 16 by cutting too deeply into the elastomeric coating 16.

In some embodiments, the frame hanger may include a metal member angled about a bend 26. The metal member may include a first segment 12 on one side of the bend and a second segment 14 on another side of the bend 26. The first segment may engage a substrate and the second segment may receive and/or support the frame fastener. An elastomeric coating 16 may cover at least a portion of the metal member. Some examples provide that a portion of the first segment 12 may be covered by the elastomeric coating 16. Some examples provide that a portion of the second segment 14 may be covered by the elastomeric coating 16.

In another exemplary embodiment, a frame hanger for preventing and/or producing lateral movement of a frame hung on a wall is provided. The frame hanger may include a hanging member 10 having a wall segment 12 and a hook segment 14. The wall segment 12 may have an interior wall face 32 and an exterior wall face 30 for engaging a wall. The hook segment 14 may have an interior hook face 34 and an exterior hook face 36 adapted to face the frame. The frame's fastener may be received and/or supported by at the interior wall face 32 and/or the interior hook face 34. An elastomeric coating 16 may cover at least a portion (if not all) of the hanging member 10. The hanging member 10 may also include coupling device(s) 20 (such as a nail, a screw, a tack, a pin, an adhesive, glue, tape and the like) for coupling and/or affixing the hanging member 10 to the wall.

In some embodiments, one or more centerline holes 28 may be added at or near the bend of the hook and/or on the bracing segment. In some examples, such centerline hole 28 may be located on the centerline of the hanger. In some embodiments, this centerline hole 28 may have a diameter in the range of 2 mm to 5 mm. The centerline hole 28 may collect any excess elastomeric coating 16 material from the bend area 26 created during the hook dipping/coating process. The centerline hole 28 may improve the elastomeric coating near the bend. The centerline hole 28 may be completely covered by elastomeric coating material 16 to form a smooth surface or be left as an indented surface. Reducing excess elastomeric coating material 16 may prevent the wire or fastener from the_{.}object being hung from cutting into the elastomeric coating material 16.

In some embodiments, and as known in the art, the shape of the hanger may be created to handle loads from very small (e.g., smaller than 5 lbs) or very large (e.g., up to or over 100 lbs). More specifically, hangers may be created to handle loads of 5-30 lbs, up to 50 lbs and up to (and over) 100 lbs, for example. Hangers for light and medium loads may include two nail holes 18 to eliminate rotation associated with traditional one nail designs which may undesirably loosen during use over time. Similarly, as is known in the art, hangers for up to 100 lbs load may have three or more holes 18. It may be advantageous (and in accordance with at least some embodiments) to add texture (such as pebbling, ribs and the like) to the elastomeric coating 16 to improve performance and/or aesthetics of the hanger.

Following from the above description and invention summaries, it should be apparent to those of ordinary skill in the art that, while the methods and apparatuses herein described constitute exemplary embodiments of the present invention, it is to be understood that the inventions contained herein are not limited to the above precise embodiment and that changes may be made without departing from the scope of the invention. Likewise, it is to be understood that it is not necessary to meet any or all of the identified advantages or objects of the invention disclosed herein in order to fall within the scope of the invention, since inherent and/or unforeseen advantages of the present invention may exist even though they may not have been explicitly discussed herein.

What is claimed is:

1. A frame hanger, comprising:
a hanging member comprising a bracing segment and a hook segment, the bracing segment adapted to engage a substrate and the hook segment adapted to receive a frame fastener; and
an elastomeric coating covering at least a portion of the hanging member.

2. The frame hanger of claim 1, further comprising:
at least one substrate fastener adapted to couple the hanging member to a substrate.

3. The frame hanger of claim 1,
wherein the hanging member further comprises at least one substrate fastener hole adapted to receive at least one substrate fastener; and
wherein the at least one substrate fastener is inserted into the at least one substrate fastener hole to couple the hanging member to the substrate.

4. The frame hanger of claim 1, wherein the elastomeric coating covering at least a portion of the hanging member covers at least a portion of the bracing segment.

5. The frame hanger of claim 1, wherein the elastomeric coating covering at least a portion of the hanging member covers at least a portion of the hook segment.

6. The frame hanger of claim 1, wherein the bracing segment comprises a bracing segment substrate-engaging surface and a bracing segment frame-facing surface.

7. The frame hanger of claim 6, wherein the elastomeric coating covering at least a portion of the hanging member covers at least a portion of the bracing segment substrate-engaging surface.

8. The frame hanger of claim 6, wherein the elastomeric coating covering at least a portion of the hanging member covers at least a portion of the bracing segment frame-facing surface.

9. The frame hanger of claim 1, wherein the hook segment comprises a hook segment frame fastener-receiving surface and a hook segment frame-facing surface.

10. The frame hanger of claim 9, wherein the elastomeric coating covering at least a portion of the hanging member covers at least a portion of the hook segment frame fastener-receiving surface.

11. The frame hanger of claim 9, wherein the elastomeric coating covering at least a portion of the hanging member covers at least a portion of the hook segment frame-facing surface.

12. The frame hanger of claim 1, wherein the hanging member comprises a metal member bent and/or stamped to distinguish the bracing segment from the hook segment.

13. The frame hanger of claim 1,
wherein the bracing segment comprises a first metal member and the hook segment comprises a second metal member; and
wherein the first metal member and the second metal member are coupled.

14. The frame hanger of claim 1, wherein the hanging member is comprised of at least one of a metal, a plastic, a rubber and a polymer.

15. The frame hanger of claim 1, wherein the hanging member further comprises at least one frame fastener hole adapted to substantially prevent the frame fastener from damaging the elastomeric coating.

16. The frame hanger of claim 1, wherein the hanging member further comprises at least one centerline hole located substantially near a junction of the bracing segment and the hook segment, the at least one centerline hole adapted to receive the elastomeric coating.

17. A frame hanger, comprising:
a metal member angled about a bend, the metal member forming a first segment of the metal member on a first side of the bend and a second segment of the metal member on a second side of the bend; and
an elastomeric coating covering at least a portion of the metal member;
wherein the first segment is adapted to engage a substrate; and
wherein the second segment is adapted to receive a frame fastener.

18. The frame hanger of claim 17, wherein the elastomeric coating covers at least one of a portion of the first segment and a portion of the second segment.

19. A frame hanger adapted to prevent lateral movement of a fastener of a frame hung on a wall, comprising:
A hanging member comprising a wall segment and a hook segment; the wall segment having an interior wall face and an exterior wall face adapted to engage a wall, the hook segment having an interior hook face and an exterior hook face adapted to face the frame;
an elastomeric coating covering at least a portion of the hanging member; and
at least one coupling device adapted to couple the hanging member to the wall;
wherein the fastener of the frame is received and supported by at least one of the interior wall face and the interior hook face.

20. The frame of claim 19,
wherein the hanging member is comprised of at least one of a metal, a plastic, a rubber and a polymer; and
wherein the at least one coupling device includes at least one of a nail, a screw, a tack, a pin, an adhesive, a glue and a tape.
